(19) United States
(12) Patent Application Publication
(10) Pub. No.: US 2024/0317932 A1
(43) Pub. Date: Sep. 26, 2024

(54) MECHANICAL FORCE SELECTIVELY RESPONSIVE AZIRIDINE POLYMER

(71) Applicant: KOREA UNIVERSITY RESEARCH AND BUSINESS FOUNDATION, Seoul (KR)

(72) Inventors: Hyo Jae YOON, Seoul (KR); Sangmin JUNG, Daejeon (KR)

(73) Assignee: KOREA UNIVERSITY RESEARCH AND BUSINESS FOUNDATION, Seoul (KR)

(21) Appl. No.: 18/564,467

(22) PCT Filed: May 26, 2022
(86) PCT No.: PCT/KR2022/007464

§ 371 Date: Jun. 12, 2024

(30) Foreign Application Priority Data
May 27, 2021 (KR) 10-2021-0068357
May 25, 2022 (KR) 10-2022-0063950

(51) Int. Cl. C08G 61/12; C08G 61/08

(52) U.S. Cl. CPC C08G 61/12; C08G 61/08; C08G 2261/143; C08G 2261/148; C08G 2261/3322; C08G 2261/418

(57) ABSTRACT

The present invention relates to a mechanophore structure of a mechanical force selectively responsive aziridine derivative and a polymer comprising same, wherein, when an aziridine derivative compound is used as a mechanophore to react to mechanical force and thermal stimulus, respectively, a covalent bond of aziridine is selectively broken by mechanical force, and thus, it has been revealed that mechanical force-only selectively responsive aziridine exists. According to the present invention, a polymer containing a mechanical force-only selectively responsive mechanophore can be manufactured, and thus can be widely used in various industrial fields such as new material fields.

### TECHNICAL FIELD

The present invention relates to a mechanophore structure that is selectively sensitive to mechanical force. More specifically, the present invention relates to an aziridine derivative as a mechanophore and a polymer containing the mechanophore that is selectively sensitive to mechanical force.

### BACKGROUND ART

Mechanochemical reactions of polymers offer a powerful platform for creating various functionalities in materials science and technology. The last decade has witnessed considerable progress in the field, permitting access to mechanochemical activation of inert catalysts, stress-sensing, materials transfer, drug release, changes in optical and electrical properties, degradation of polymer. Moreover, mechanical force provides the ability to induce and control chemical reactions toward routes that are forbidden under traditional photochemical and thermal conditions. Mechanochemical reactions of polymers are triggered by chemical structures (mechanophores) designed to facilitate chemical transformations upon exposure to external force.

Most mechanochemical reactions that have been reported thus far can be categorized as follows: i) retro-[2+2], [4+2], and [4+4] cycloadditions, ii) 271, 471, and 671 electrocyclic ring opening reactions, iii) homolytic reactions and iv) heterolytic reactions. Many mechanophores respond sensitively to both thermal and photochemical stimuli, yet the reaction routes differ from each other. Such a universal reactivity of mechanophore makes it difficult to couple orthogonally mechanochemical reactions with other reactions that proceed under traditional photochemical and thermal conditions. For instance, catalysts devised to be activated by mechanical force can be undesirably activated by external stimuli other than mechanical force. Polymers designed to degrade in response to mechanical force can lose durability due to decomposition triggered by heat or light in daily-life environments.

In this connection, Pankova et al. developed N-phthalimidoaziridine with aryl substituents on both carbons and disclosed that the aziridine undergoes heat-induced 1,2-migration reaction of the aziridine nitrogen substituent (Alena S. Pankova, et al., Tetrahedron Lett. 2015, 56, 5381-5385). However, this study failed to show the heat-induced 1,2-migration reactivity of aziridine with alkyl substituents on both carbons.

Klukovich et al. introduced gem-dibromocyclopropane, which is a three-membered cyclic compound structurally similar to aziridine, into polybutadiene and disclosed mechanical force-induced isomerization of the introduced gem-dibromocyclopropane (Jeremy. M. Lenhardt, et al., J. Mater. Chem. 2011, 21, 8454-8459). However, the reaction of the compound is induced by heat as well as by mechanical force.

A handful of research groups have reported on mechanical force-selective activation of mechanophores.

### DETAILED DESCRIPTION OF THE INVENTION

### Problems to be Solved by the Invention

Under these circumstances, the present inventors have earnestly and intensively conducted research to develop a polymer that exhibits mechanical force-selective cleavage of a chemical bond, resulting in a structural change. As a result, the present inventors have found that the application of mechanical force to aziridine, which is a three-membered N-heterocyclic compound, as a mechanophore induces cleavage of the aziridine's covalent bond, resulting in a structural change. The present inventors have also found that aziridine is structurally stable under traditional thermal conditions and can react to yield a product whose structural change is selectively induced by mechanical force. The present invention has been accomplished based on these findings.

Thus, the present invention is intended to provide an aziridine derivative as a mechanophore structure that is selectively sensitive to mechanical force and a polymer containing the mechanophore structure that is selectively sensitive to mechanical force.

### Means for Solving the Problems

One aspect of the present invention provides a mechanophore structure that does not respond to heat or light but responds selectively to mechanical force, the mechanophore structure being represented by Formula 1:

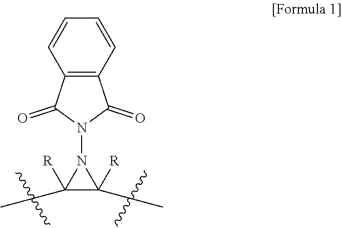

wherein the groups R are the same as or different from each other and are each independently a hydrogen atom, a halo group or an aryl group.

According to one embodiment of the present invention, the mechanophore structure may respond selectively to mechanical force, resulting in cleavage of the aziridine's C—C covalent bond.

According to one embodiment of the present invention, the mechanical force may be ultrasonication.

According to one embodiment of the present invention, the mechanophore structure may be selected from the structures represented by Structural Formulas 1:

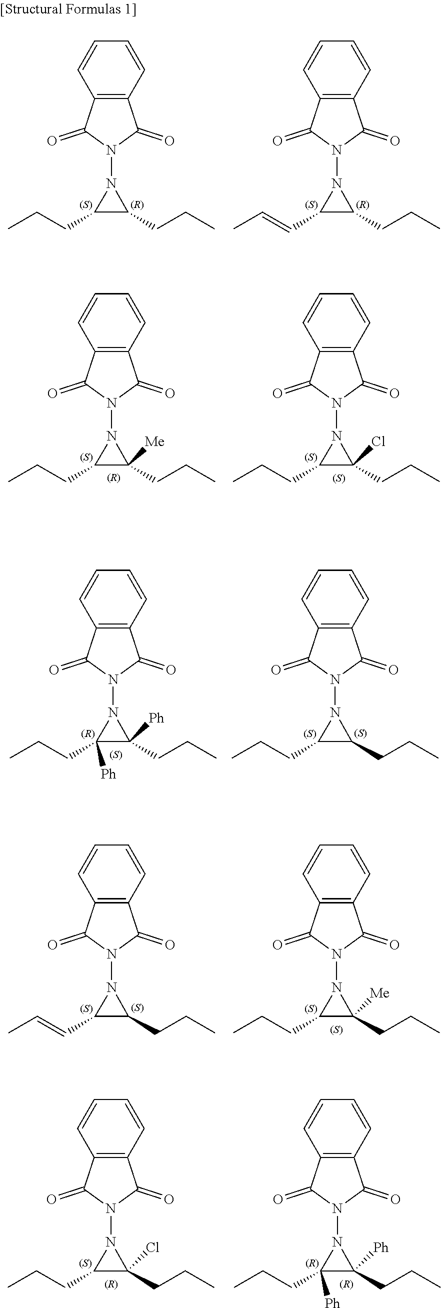

A further aspect of the present invention provides a polymer including a repeating unit containing the mechanophore structure, the repeating unit being represented by Formula 1-1 or 1-2:

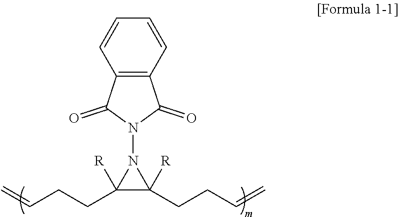

wherein the groups R are the same as or different from each other and are each independently a hydrogen atom, a halo group or an aryl group, and m is an integer from 199 to 203,

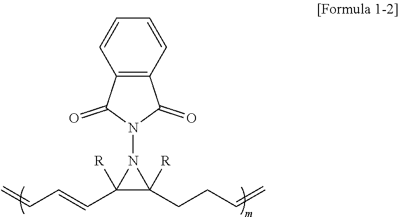

wherein R and m are as defined in Formula 1-1.

According to one embodiment of the present invention, the C—C covalent bond of aziridine in the repeating unit of Formula 1-1 or 1-2 may be cleaved by mechanical force, resulting in a ring opening reaction to yield an imine derivative.

Another aspect of the present invention provides a polymer including a repeating unit represented by either Formula 1-1 or 1-2:

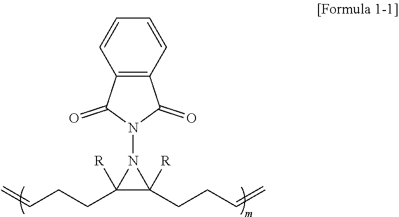

wherein the groups R are the same as or different from each other and are each independently a hydrogen atom, a halo group or an aryl group, and m is an integer from 199 to 203,

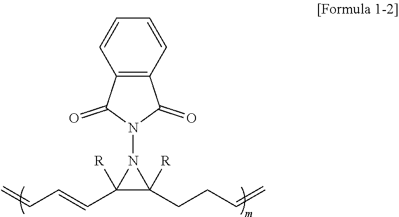

wherein R and m are as defined in Formula 1-1, and a repeating unit represented by Formula 1-3:

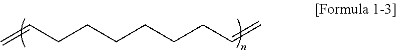

wherein n is an integer from 199 to 203.

According to one embodiment of the present invention, the C—C covalent bond of aziridine in the repeating unit of Formula 1-1 or 1-2 may be cleaved by mechanical force, resulting in a ring opening reaction to yield an imine derivative.

According to one embodiment of the present invention, the polymer may be represented by Formula 1-4:

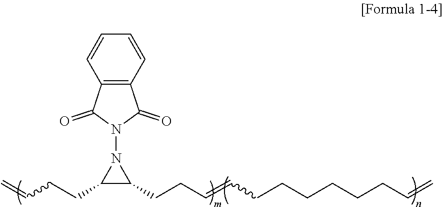

wherein each of m and n is independently an integer from 199 to 203.

### Effects of the Invention

It was found that when the aziridine derivative of the present invention as a mechanophore is allowed to respond to mechanical force and thermal stimuli, the covalent bond of aziridine is selectively cleaved by mechanical force, revealing the presence of aziridine selectively sensitive to mechanical force. Due to the presence of the mechanophore therein, the polymer of the present invention can be widely used in various industrial fields, including new materials.

### BRIEF DESCRIPTION OF THE DRAWINGS

FIG. 1 shows A) a reaction for the synthesis of a large amount of an aziridine-containing polymer P according to the present invention, specifically a cis-N-phthalimidoaziridine embedded copolymer P from 8-membered cyclic monomer M through entropically driven ring opening metathesis copolymerization (ED-ROMP), B) ¹H spectra for compounds M and P, and C) a gel permeation chromatogram for compound P.

FIG. 2 shows the results of ¹H NMR analysis to confirm changes in the chemical structure of an aziridine polymer P according to the present invention after mechanochemical and thermal reactions of P. Specifically, A) shows the results of mechanochemical and thermal reactions of P to yield products P1 and P2, respectively, and B) compares ¹H NMR spectra for P, P1, and P2.

FIG. 3 shows the results of ¹H NMR analysis to confirm changes in the chemical structure of a polymer P1, which is activated through a mechanochemical reaction, after hydrolysis of P1.

FIG. 4 shows simulation of tensile stress-induced structural changes in cis-N-phthalimidoaziridine. Specifically, FIG. 4 shows the results of constrained geometries simulate external force (CoGEF) calculation using density functional theory at the B3LYP/6-31G* level to confirm the mechanism of mechanical force-induced structural changes in an aziridine polymer P of the present invention. More specifically, A) shows an increase in the distance between terminal methyl groups (Δd, Å), B) shows plots of relative energy as a function of the change in d relative to intact aziridine (Δd, Å), C) shows a plot of the N—N bond length, D) shows plots of natural atomic charge (NAC) of the aziridine's two carbon atoms, and E) shows plots of NAC of the phthalimido group's nitrogen atom.

FIG. 5 shows the structures of various N-phthalimidoaziridine derivatives that can be derived from olefinic polymers.

FIG. 6 shows a top-down approach for the synthesis of an N-phthalimidoaziridine polymer and the results of ¹H NMR analysis to confirm structural changes in the polymer after a mechanochemical reaction. Specifically, A) shows aziridination of cis-PB and sequential mechanochemical and hydrolysis reactions of cis-Azi PB and B) shows ¹H NMR characterization of activated species in cis-Azi PB.

FIG. 7 is a conceptual diagram showing the reaction of an aziridine polymer according to one embodiment of the present invention that is selectively sensitive to mechanical force, specifically mechanical force selective transformation of N-phthalimidoaziridine into imine.

### BEST MODE FOR CARRYING OUT THE INVENTION

The present invention will now be described in more detail.

Unless otherwise defined, all technical and scientific terms used in this specification have the same meaning as commonly understood by a person skilled in the art to which the present invention pertains. In general, the nomenclature used herein is well known and commonly used in the art.

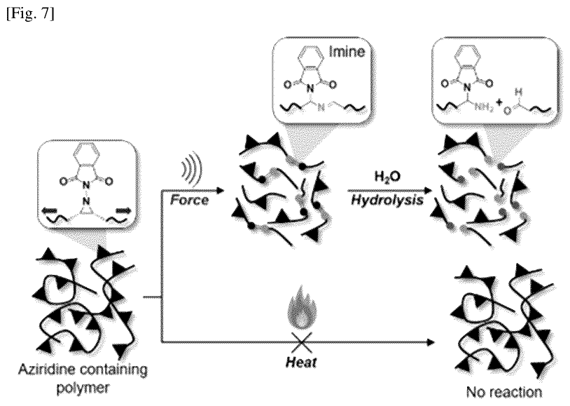

FIG. 7 is a conceptual diagram showing the reaction of an aziridine polymer according to one embodiment of the present invention that is selectively sensitive to mechanical force. Specifically, FIG. 7 shows mechanical force selective transformation of N-phthalimidoaziridine into imine.

As shown in FIG. 7, selective migration in N-phthalimidoaziridine incorporated into an aliphatic backbone occurs. A pulling force along the backbone transduced by ultrasonication activates the aziridine ring structure and induces 1,2-migration of N-phthalimido group, thereby leading to the ring opening reaction and yielding the corresponding imine. The imine is hydrolyzed into amine and aldehyde in the presence of water under ambient conditions. These sequential reactions are verified by chemical structure analysis of polymers using ¹H NMR spectroscopy.

Constrained geometries simulate external force (CoGEF) simulations reveal that the applied force increases the charge unbalance between the aziridine carbon and the nitrogen of phthalimido moiety and activates the N—N bond whose axis is orthogonal to the force direction. This electronic structural change supports the mechanism of force-induced migration.

As a result of evaluating the substrate scope of the mechanochemical reaction with the CoGEF calculations, the values of Fₘₐₓ for polybutadiene (PB), polyacetylene (PA), polyisoprene (PI), polychloroprene (PC), and diphenyl polyene (DP) were found to fall into the Fₘₐₓ range of mechanochemical 2π electrocyclic ring opening (≤5.7 nN). To prove this experimentally, cis-PB is modified to bear N-phthalimidoaziridine, and thereafter, transformation into the corresponding imine is confirmed.

The present invention is intended to provide a novel mechanophore structure that exhibits mechanical force-selective cleavage of a chemical bond, resulting in a structural change, and a polymer in which the mechanophore structure is embedded.

In the Examples section that follows, the application of mechanical force to aziridine, which is a three-membered N-heterocyclic compound, as a mechanophore was found to induce cleavage of the aziridine's covalent bond, resulting in a structural change. It was also found that aziridine is structurally stable under traditional thermal conditions and can react to yield a product whose structural change is selectively induced by mechanical force.

### MODE FOR CARRYING OUT THE INVENTION

The present invention will be more specifically explained with reference to the following examples. It will be evident to those skilled in the art that these examples are merely for illustrative purposes and are not to be construed as limiting the scope of the present invention. Therefore, the true scope of the present invention is defined by the appended claims and their equivalents.

The present inventors have recently probed the potential of aziridine for a mechanophore. The trivalency of nitrogen atom allows fine-tune reactivity of aziridine. To design force-sensitive and thermal-insensitive aziridine mechanophore, the present 5 inventors have focused on aziridine with N-phthalimido moiety. Under thermal condition, N-phthalimidoaziridine with C-aryl substituents undergoes 1,2-migration of N-phthalimido group to afford an imine. When more than one aryl group is substituted on the aziridine carbon, the azomethine ylide intermediate formed under thermal conditions can be stabilized. The present inventors hypothesized that, if the aryl substituents are replaced with alkyl ones, force-selective migration can occur. The hypothesis was confirmed through the following examples, including synthesis examples.

### Synthesis Example 1: Synthesis of Cis-N-Phthalimidoaziridine Copolymer P

Cis-N-phthalimidoaziridine copolymer P according to one embodiment of the present invention was synthesized by Reaction Scheme 1:

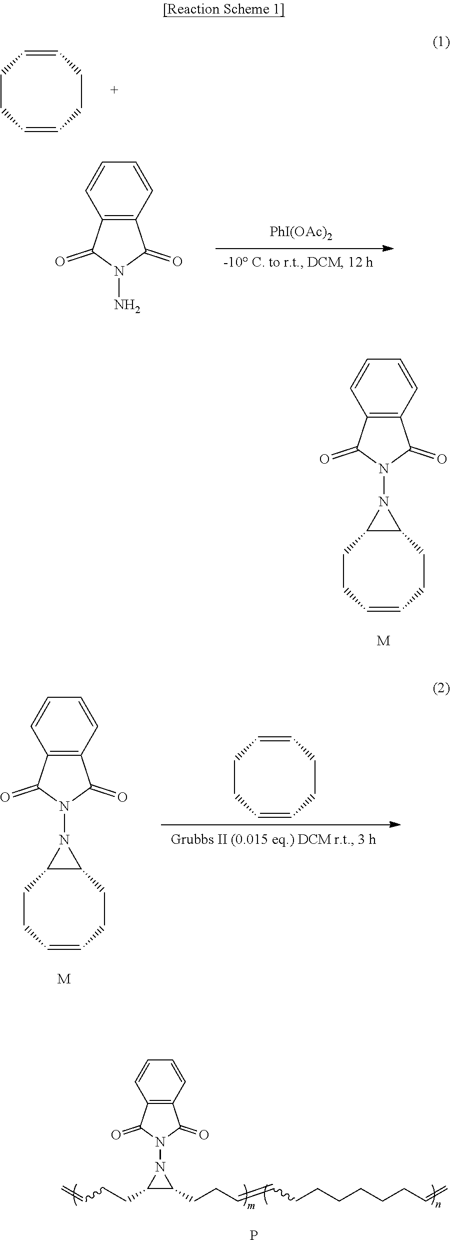

### (1) Synthesis of 2-((1R,8S,Z)-9-azabicyclo[6.1.0]non-4-en-9-yl)isoindoline-1,3-dione M

Cis,cis-1,5-cyclooctadiene (1.62 mL, 18.5 mmol, 3.0 eq.) was added to a solution of N-aminophthalimide (1.00 g, 6.17 mmol, 1.0 eq.) and (diacetoxyiodo)benzene (1.41 g, 4.63 mmol, 0.75 eq.) in anhydrous dichloromethane (30 mL) at −10° C. The reaction mixture was stirred at room temperature for 12 h. After completion of the reaction, the transparent solution was diluted with dichloromethane (30 mL). The resulting mixture was washed with water (3×30 mL) and dried over MgSO₄. The desiccant was filtered off, the solvent was removed in vacuo, and the residue was separated by silica gel column chromatography (silica gel, 25% EtOAc in Hex) to afford products as yellowish powders. (0.48 g, 2.96 mmol, 48% yield).

¹H NMR (500 MHz, CDCl₃) δ: 7.76 (m, 2H), 7.67 (m, 2H), 5.60 (m, 2H), 2.62 (m, 2H), 2.44 (m, 4H), 2.31 (m, 2H), 2.07 (m, 2H) ppm. ¹³C NMR (500 MHz, CDCl₃) δ: 24.32, 27.76, 48.65, 122.83, 129.05, 130.53, 133.85, 165.08 ppm.

HRMS (ESI) m/z: [M+Na]⁺ calcd for C₁₆H₁₆N₂NaO₂: 291.1109; found: 291.1107.

### (2) Synthesis of Cis-N-Phthalimidoaziridine Copolymer P

M (0.2 g, 0.75 mmol, 1.0 eq.) and cis-cyclooctene (0.082 g, 0.75 mmol, 1.0 eq.) were dissolved in 0.3 mL of anhydrous dichloromethane (DCM) in a round bottom flask. Grubbs's 2nd generation catalyst (92.0 mg) was dissolved in DCM (1 mL), and 0.1 mL of the resulting solution was added to the reaction solution. The viscosity of the solution was increased after 30 min and 0.1 mL of DCM was added to the solution. The stirring was continued for another 3 h. To the reaction solution was added methanol. The precipitate was redissolved in DCM and reprecipitated in methanol. The solvents were removed with an oil pump equipped with a cooling trap, affording 0.25 g of a polymer.

¹H NMR (500 MHz, CDCl₃) δ: 7.67 (m, 4H), 5.46 (m, 4.5H), 2.58 (m, 2H), 2.37 (m, 4H), 2.06 (m, H), 2.01 (m, 5H), 1.82 (m, 2H), 1.59 (m, 2.5H), 1.29 (m, 10.5H).

¹³C NMR (500 MHz, CDCl₃) δ: 14.12, 22.64, 29.09, 29.69, 31.58, 32.61, 48.35, 122.80, 129.23, 130.48, 133.88, 162.18 ppm.

Mₙ=81.3 kDa, Mw=487.7 kDa, PDI=6.0.

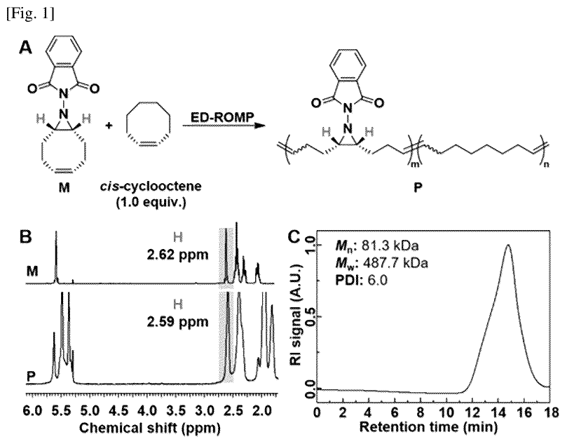

A bottom-up reaction for the synthesis of a polymer from a monomer was used to synthesize a large amount of the aziridine-containing polymer (P in A of FIG. 1).

An eight-membered cyclic monomer containing cis-N-phthalimidoaziridine (M in A of FIG. 1) was prepared from cis,cis-1,5-cyclobutadiene in one step.

The synthesis of a large amount of the aziridine-containing polymer was confirmed by ¹H NMR spectroscopy and gel permeation chromatography (FIG. 1). The proton resonance of aziridine's carbon at δ=2.62 ppm was indicative of formation of the desired aziridine ring (B of FIG. 1). Entropically driven ring opening metathesis polymerization (ED-ROMP) of compound M and cis-cyclooctene at 1:1 molar ratio in the presence of Grubbs 2nd generation catalyst yielded cis-N-phthalimidoaziridine embedded copolymer P.

¹H NMR analysis indicated that the molar ratio of monomers was well reflected into the polymer chain structure. The proton resonance of the aziridine carbon in the copolymer P was observed at δ=2.59 ppm (B of FIG. 1), which was consistent with that of monomer M and indicative of the retention of aziridine ring structure after the polymerization. C of FIG. 1 shows a gel permeation chromatogram of copolymer P; the number average molecular weight (Mₙ), weight average molecular weight (M_{w}), and polydispersity index (PDI) were revealed to be 81.3 kDa, 487.7 kDa, and 6.0, respectively.

### Example 1: Mechanochemical Reaction of the Aziridine Polymer

Ultrasound (20 kHz, 30% amplitude; pulse sequence: 1 sec on/1 sec off) was applied to the copolymer P dissolved in anhydrous toluene at 4-8° C. under N₂ atmosphere.

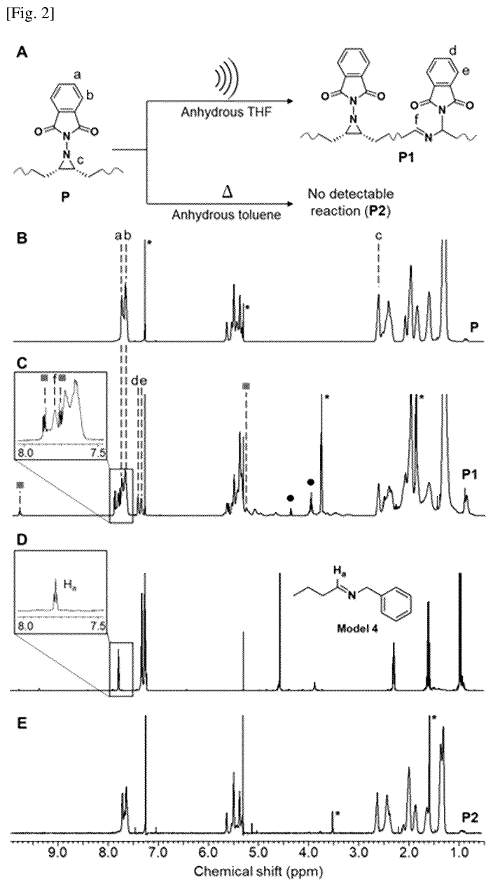

After ultrasonication for 2 h, ¹H NMR analysis revealed the appearance of new proton resonances at δ=8.10 and 4.69 ppm, which corresponded to protons of imine and its α-carbon, respectively (P1 in B of FIG. 2). A new, small peak at δ=9.76 ppm was also detected, indicative of formation of aldehyde species resulting from decomposition of imine via hydrolysis by atmospheric water.

### Example 2: Thermal Reaction of the Aziridine Polymer

To evaluate the thermal stability of copolymer P, its toluene solution was refluxed for 24 h. There was no detectable chemical structural change in ¹H NMR spectrum (P2, B of FIG. 2) compared to the copolymer P before reaction. This finding indicates that the 1,2-dialkyl-substituted cis-N-phthalimidoaziridine is chemically inert under thermal condition but considerably reactive under mechanochemical condition.

### Example 3: Hydrolysis of the Polymer Activated Through the Mechanochemical Reaction

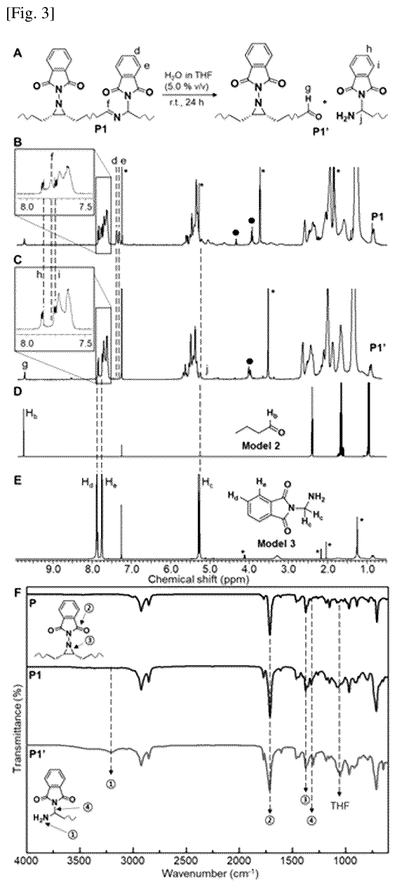

The imine resulting from the mechanical force-induced migration reaction underwent hydrolytic cleavage, bifurcating into amine and aldehyde (A of FIG. 3).

Upon addition of water (5.0% v/v) into the THF solution containing the imine product P1 (1 mg/mL), a new proton resonance at δ=9.76, which corresponded to the aldehyde proton, appeared while the intensity of imine proton peak at δ=8.10 ppm was significantly reduced (B of FIG. 3). Molecular weight analysis before and after the hydrolysis revealed reduced M₁ by 28.0%.

### Example 4: Investigation of Mechanism of Mechanical Force-Induced Structural Change of the Aziridine Polymer

To explain the mechanism of the mechanochemical cycloaddition, constrained geometries simulate external force (CoGEF) calculation was performed using density functional theory (DFT) at the B3LYP/6-31G* level.

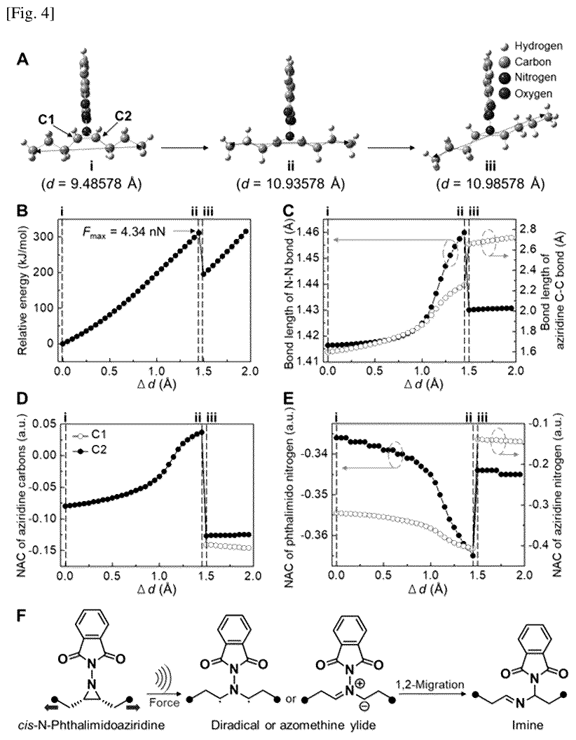

To simulate the mechanical force-induced structural change of cis-N-phthalimidoaziridine, the distance between terminal methyl substituents (Δd, Å) gradually increased, as shown in A of FIG. 4. At the initial stage (i-ii region in FIG. 4), the increase in Δd led to (1) a gradual increase in the relative energy (B of FIG. 4), (2) an exponential increase in the N—N bond length (C of FIG. 4), (3) increases toward positive and negative in the natural atomic charge (NAC) of aziridine carbons (D of FIG. 4) and phthalimido nitrogen (E of FIG. 4), respectively. The C—C bond of aziridine was finally cleaved at Δd=1.45 Å (the iii position in FIG. 4).

The simulation study provided two key implications.

First, the mechanical force applied to the polymer backbone stretches the C—C bond of aziridine, which in turn causes significant charge unbalance between the aziridine's carbon and the nitrogen atom of phthalimido moiety. This finding supports that, upon application of mechanical force to cis-N-phthalimidoaziridine, the N—N bond is activated, and the electron-rich phthalimido nitrogen attacks the electron-deficient aziridine carbon via 1,2-migration.

Second, Fₘₐₓ—the parameter enabling relative comparison of mechanochemical reactivity between different mechanophores—was revealed to be 4.34 nN. Recently, theoretical work by Klein et al. revealed that 2π electrocyclic mechanophores such as aziridine, epoxide, and gem-dihalocyclopropane can undergo mechanochemical transformation reactions in the range of 3.2-5.7 nN. The calculated Fₘₐₓ value fell into the range, proving the mechanochemical activation at the C—C bond of aziridine.

### Example 5: Evaluation of Substrate Scope and Applicability of the Inventive Mechanism

To evaluate the substrate scope of mechanical force-induced 1,2-migration reaction and the applicability of the force-induced migration to polymers widely used in daily life, CoGEF calculations were conducted over N-phthalimidoaziridine derivatives that can be formed on synthetic olefinic polymers including polybutadiene (PB), polyacetylene (PA), polyisoprene (PI), polychloroprene (PC), and diphenyl polyene (DP).

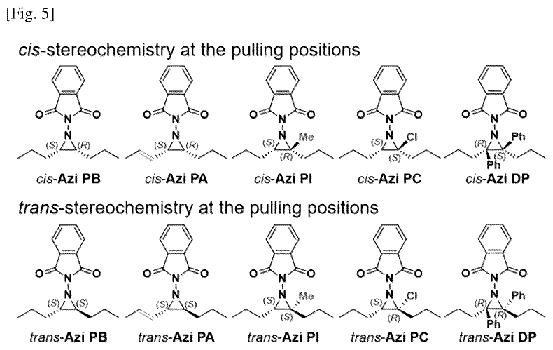

CoGEF simulations were performed over stereochemically pure N-phthalimidoaziridine derivatives shown in FIG. 5 and Fₘₐₓ values were obtained. As summarized in Table 1, all the aziridines exhibited higher Fₘₐₓ values (by 1.27-3.41 nN) in trans-isomers than cis-isomers, and the Fₘₐₓ values were lower than 5.7 nN, proving their potential as a mechanophore, except the trans-Azi PA and trans-Azi DP.

TABLE 1

| | | Activation of | |
|---|---|---|---|
| Stereochemistry | Structure | aziridine C-C bond | Fₘₐₓ (nN) |
| cis | Azi PB | ◯ | 4.34 |
| | Azi PA | ◯ | 2.77 |
| | Azi PI | ◯ | 3.70 |
| | Azi PC | ◯ | 3.70 |
| | Azi DP | ◯ | 2.54 |
| trans | Azi PB | ◯ | 5.61 |
| | Azi PA | ◯ | 6.18 |
| | Azi PI | ◯ | 5.45 |
| | Azi PC | ◯ | 5.07 |
| | Azi DP | X | — |

In the simulation results, trans-Azi DP underwent a bond scission in the C—C bond of alkyl substituent and aziridine carbon, rather than the aziridine's C—C bond, implying its low mechanochemical reactivity and suggesting a competition between the polymer backbone and the aziridine's C—C bond for mechanical force.

Despite the high value of Fₘₐₓ (6.18 nN; Table 1), trans-Azi PA exhibited cleavage of the aziridine's C—C bond, which indicates that the Fₘₐₓ value required for the mechanochemical 2π electrocyclic ring opening reactions of three-membered ring mechanophores may have a value greater than previously known values.

### Example 6: Synthesis of N-Phthalimidoaziridine Polymer Through Top-Down Approach and Mechanochemical Reaction of the Polymer to Verify the Simulation

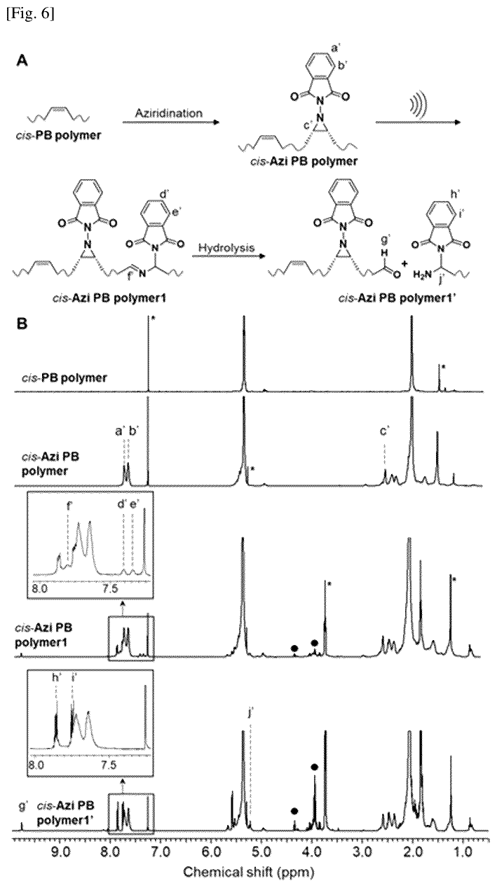

To verify the simulation results, N-phthalimidoaziridine embedded polymer (cis-Azi PB) was synthesized from cis-polybutadiene (cis-PB) (FIG. 6) through oxidative addition of N-aminophthalimide.

Force was applied to the synthesized polymer under the same conditions as those of P. In ¹H NMR analysis, imine and aldehyde peaks were observed at 8.38 ppm and 9.77 ppm, respectively (B of FIG. 6). As a result of additional hydrolysis, the imine peak disappeared (B of FIG. 6).

Although the particulars of the present invention have been described in detail, it will be obvious to those skilled in the art that such particulars are merely preferred embodiments and are not intended to limit the scope of the present invention. Therefore, the substantial scope of the present invention is defined by the appended claims and their equivalents.

### INDUSTRIAL APPLICABILITY

It was found that when the aziridine derivative of the present invention as a mechanophore is allowed to respond to mechanical force and thermal stimuli, the covalent bond of aziridine is selectively cleaved by mechanical force, revealing the presence of aziridine selectively sensitive to mechanical force. Due to the presence of the mechanophore therein, the polymer of the present invention can be widely used in various industrial fields, including new materials.

1. A mechanophore structure that does not respond to heat or light but responds selectively to mechanical force, the mechanophore structure being represented by Formula 1: 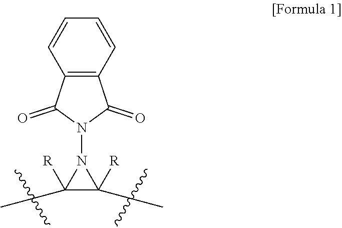
wherein the groups R are the same as or different from each other and are each independently a hydrogen atom, a halo group or an aryl group.

2. The mechanophore structure according to claim 1, wherein the mechanophore structure responds selectively to mechanical force, resulting in cleavage of the aziridine's C—C covalent bond.

3. The mechanophore structure according to claim 1, wherein the mechanical force is ultrasonication.

4. The mechanophore structure according to claim 1, wherein the mechanophore structure is selected from the structures represented by Structural Formulas 1:

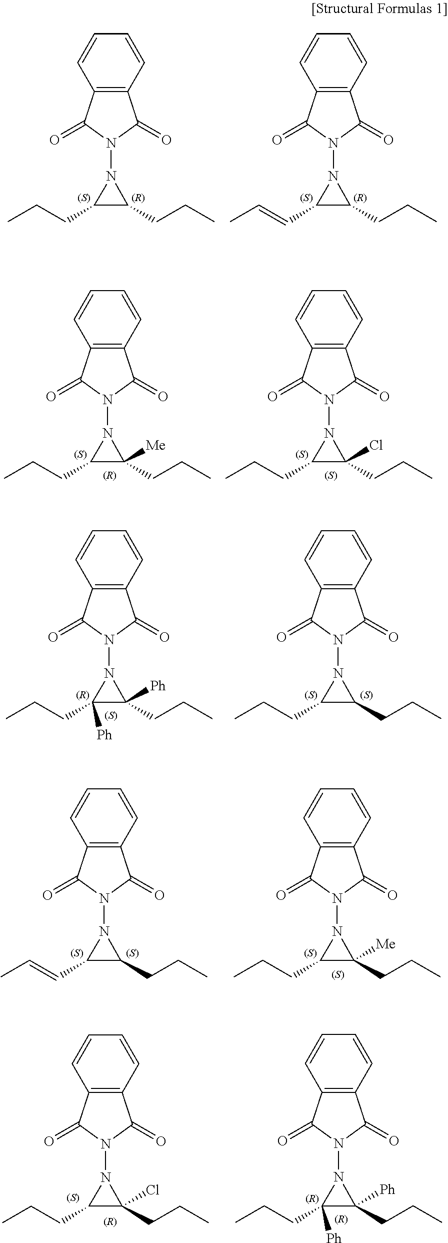

5. A polymer comprising a repeating unit represented by Formula 1-1 or 1-2: 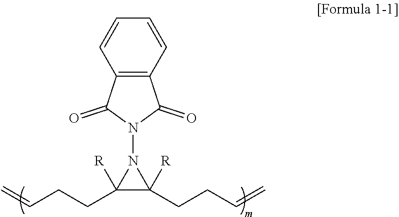
wherein the groups R are the same as or different from each other and are each independently a hydrogen atom, a halo group or an aryl group, and m is an integer from 199 to 203, 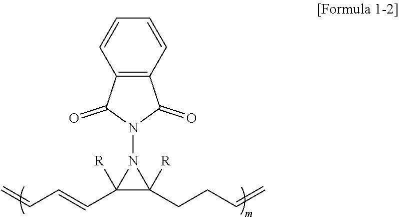
wherein R and m are as defined in Formula 1-1.

6. The polymer according to claim 5, wherein the C—C covalent bond of aziridine in the repeating unit of Formula 1-1 or 1-2 is cleaved by mechanical force, resulting in a ring opening reaction to yield an imine derivative.

7. A polymer comprising a repeating unit represented by either Formula 1-1 or 1-2: 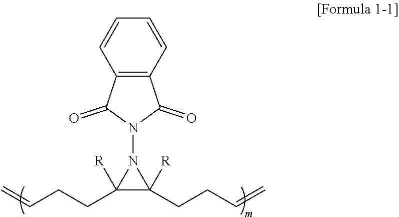
wherein the groups R are the same as or different from each other and are each independently a hydrogen atom, a halo group or an aryl group, and m is an integer from 199 to 203, 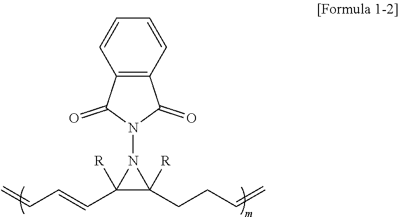
wherein R and m are as defined in Formula 1-1, and a repeating unit represented by Formula 1-3: 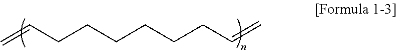
wherein n is an integer from 199 to 203.

8. The polymer according to claim 7, wherein the C—C covalent bond of aziridine in the repeating unit of Formula 1-1 or 1-2 is cleaved by mechanical force, resulting in a ring opening reaction to yield an imine derivative.

9. The polymer according to claim 7, wherein the polymer is represented by Formula 1-4: 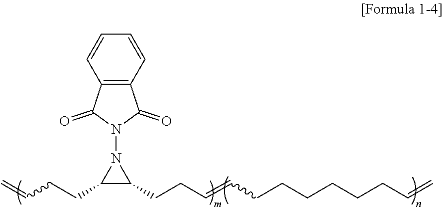
wherein each of m n and n is independently an integer from 199 to 203.
